(19) United States
(12) Patent Application Publication
(10) Pub. No.: US 2021/0304014 A1
(43) Pub. Date: Sep. 30, 2021

(54) Omnitextual Manuscript Dating System

(71) Applicant: Patricia Fleming Sanders, Helena, AL (US)

(72) Inventor: Patricia Fleming Sanders, Helena, AL (US)

(21) Appl. No.: 17/216,569

(22) Filed: Mar. 29, 2021

Related U.S. Application Data
(60) Provisional application No. 63/002,043, filed on Mar. 30, 2020.

(51) Int. Cl. G06N 5/00; G06F 16/23; G06N 20/20; G06N 5/04

(52) U.S. Cl. CPC G06N 5/003; G06N 5/04; G06N 20/20; G06F 16/2365

(57) ABSTRACT

The system and methods for dating ancient manuscripts are disclosed. An objective date prediction is obtained, along with supporting evidence, for undated ancient manuscripts using a decision-tree based, omnitextual model and decision tree ensemble processing in an interactive system. The system may also be used for verifying or refuting the dates of paleographically dated manuscripts. In addition, the system allows for user interaction due to the graphical nature of decision trees and thus, also provides a heuristic function in the dating of ancient manuscripts.

### CROSS-REFERENCE TO RELATED APPLICATIONS

This application claims priority from and is submitted as an amendment to provisional patent application No. 63/002,043, filed Mar. 30, 2020 to request the conversion of the provisional application to a nonprovisional application.

### FEDERALLY SPONSORED RESEARCH OR DEVELOPMENT

(Not Applicable)

### NAMES OF THE PARTIES TO A JOINT RESEARCH AGREEMENT

(Not Applicable)

### INCORPORATION-BY-REFERENCE OF MATERIAL SUBMITTED ON A COMPACT DISC OR AS A TEXT FILE

(Not Applicable)

### PRIOR DISCLOSURES BY THE INVENTOR OR JOINT INVENTOR

(Not Applicable)

### BACKGROUND OF THE INVENTION

### A. Field of the Invention

The present proposal relates to the paleographical dating of ancient manuscripts. Specifically, the present proposal describes a new software application that (1) aids in the objective dating of ancient manuscripts using decision tree modeling and analysis, and (2) performs a heuristic function in helping users understand the role of a manuscript's attributes in producing a plausible date range for an undated manuscript.

Traditionally, paleographers have determined the date of an undated ancient manuscript by comparing it with other datable manuscripts that have been categorized according to their style of handwriting. However, styles of handwriting are modern categories imposed on ancient handwriting practices, and thus, the process of assigning manuscript samples to categories of style is subjective and yields controversial results. As a result, undated ancient manuscripts are sometimes misdated, adding unjustified value when antedated, whether by mistake or for antiquarian consideration. In addition, forgeries, where manuscripts are made to appear ancient, are a recurring problem, misleading unsuspecting collectors, curators, and patrons of museums and libraries. Furthermore, scientific methodologies like carbon-14 dating and spectroscopy may damage an ancient manuscript, and they do not allow the paleographer to participate in the analysis that is performed for learning purposes.

In this proposal, decision tree methodology is applied to the field of paleography for more accurately predicting ancient manuscript date ranges based on evidence derived from dated ancient manuscripts. A decision tree is a graphical tool which will be used for both modeling and quantitative analysis to add objectivity to the process of dating ancient manuscripts and to help users learn to date ancient manuscripts more accurately.

### B. Description of Related Art

No related art was determined in a search of the USPTO Full Text and Image Database.

### BRIEF SUMMARY OF THE INVENTION

### A. High Level Description

The Omnitextual Manuscript Dating System processes an ensemble of decision trees to produce a plausible and secure date range for undated manuscripts. The program compares (1) a decision tree model of attributes from dated manuscripts with (2) input by the computer program user on the same attributes in his or her undated test manuscript, in order to determine a reasonable date-range for the undated manuscript. The decision tree model is derived from a comprehensive list of attributes for ancient dated manuscripts that includes paleographical, orthographical, and codicological features, such as the forms of letters and ligatures in a scribe's handwriting, punctuation, abbreviations, and the materials used to make the manuscript; thus, the designation of omnitextual has been applied to this new approach, since it encompasses potentially every distinct feature of a manuscript. To obtain input from the user on the attributes of their undated manuscript, the graphical display of a sequence of decisions regarding the undated manuscript's attributes, based on the model of ancient dated manuscripts, provides an interactive interface that allows a user to follow an analysis easily and learn how the attributes work together to determine the date of their undated manuscript. In this way, the program can be used not only to produce a reasonable date range for an undated manuscript, but also as a heuristic tool to teach students and researchers how to date ancient manuscripts. Alternatively, the user can provide the required input in an attribute file for the test manuscript, if desired, which would be imported into the program.

### B. Regarding Invention Embodiments

Ancient manuscripts are extant in many languages, such as Greek, Latin, Hebrew, and Coptic, etc., as well as scripts, such as majuscule and minuscule. In addition, ancient manuscripts may be categorized by type of text, such as literary or documentary (for example: wills, deeds, and receipts). Dated manuscripts are those that are internally dated, often in a colophon, or otherwise securely dated (for example: by dateable content, a dated document on the opposite side of a reused page, or a fixed archeological context). When extant dated manuscripts can be identified in order to create a model of any given domain comprised of a specific language, script, and type of text, this program can compare that model to a corresponding undated manuscript to obtain an objective date range for the undated manuscript. For example, a prototype for this software used a model developed from dated Greek minuscule literary manuscripts. An added benefit is that the graphical presentation of the decision tree model can be used as a learning tool for students and researchers regarding the dating of manuscripts.

### C. Regarding the Development of a Decision Tree Model of Manuscripts as Program Input

The program requires a decision tree model of manuscripts as input. To develop an understanding of the domain of a particular language, script, and type of text, primary and secondary sources may be analyzed to identify the domain's data attributes and values. Then a set of manuscripts, called the training set, of the same domain should be analyzed to record the date range, usually in centuries though not necessarily, in which the corresponding attributes and values are found. The date range could be in any discernable increment of time, such as centuries, half-centuries, or quarter-centuries, for example. Another set of manuscripts, called the test set, should be used to verify the validity of the model.

As an example, in the prototype for this project, the works of paleographers were surveyed to identify common attributes in the domain of ancient Greek minuscule literary manuscripts. Then thirty dated Greek minuscule literary manuscripts from four libraries were analyzed for the values related to these attributes for the classification of manuscripts by century. For instance, one attribute of ancient manuscripts is the format. The distinct values are roll and codex, with each value having an observable beginning and ending date for its use. The thirty manuscripts were divided into two sets. First, the training set consisted of twenty-two dated manuscripts, which were used to develop a decision tree model. Those attributes and values that were not determined reliable for dating manuscripts (for example, an attribute found in only one manuscript) were pruned from the model. Second, the test set consisted of eight dated manuscripts, which were used to validate the model by a comparison of the attributes of the test set with the model. The test results produced the correct century for every manuscript tested, which validated the model. The successful results also indicate a decision tree model will provide a comprehensive set of objective comparison criteria to determine a secure date range for those manuscripts that are undated.

### EXPLANATION OF FIGURES

### A. High Level View

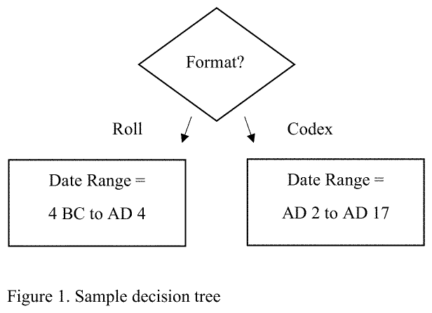

FIG. 1 provides an example of a single decision tree. Decision trees can be read such that if-then-else rules can be derived from the tree. For example, tithe “format” of a Greek manuscript equals “codex,” then the date range for that attribute is from x toy centuries. Decision trees are commonly displayed in many graphical formats. As an alternative,

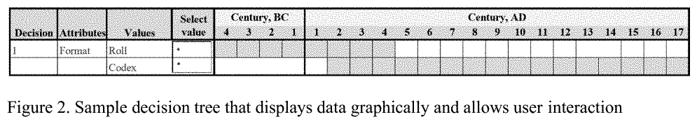

FIG. 2 provides the same decision tree displayed in a table format that allows user interaction and displays the data graphically. In this example, the user can select roll or codex for the format attribute that matches his or her undated test manuscript, and the date range when those values were found in ancient manuscripts is displayed graphically for learning purposes.

A parent tree can be implemented to ensure that the user is using the correct model that matches their manuscript's domain.

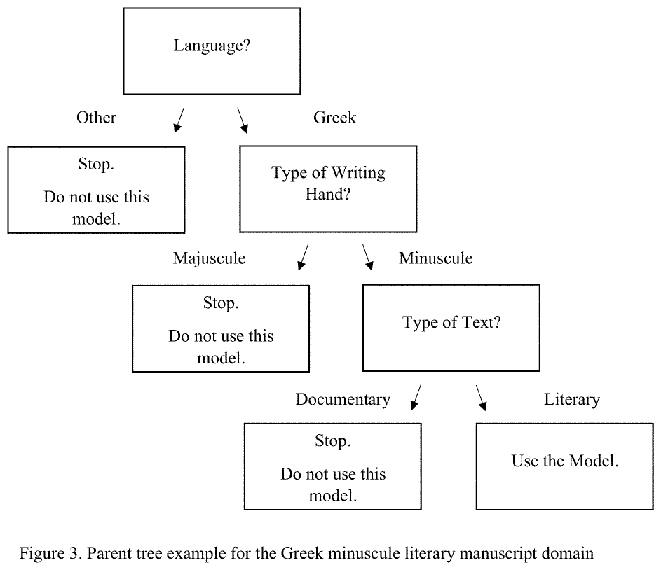

FIG. 3 shows an example of a parent tree for the Greek minuscule literary manuscript domain that was used as a prototype. If the user attempts to choose an option outside of this domain, the parent tree instructs the user not to use this embodiment of the tool. If the user can proceed down the right-hand side of the levels of the decision tree, then he or she can use the model. Alternatively,

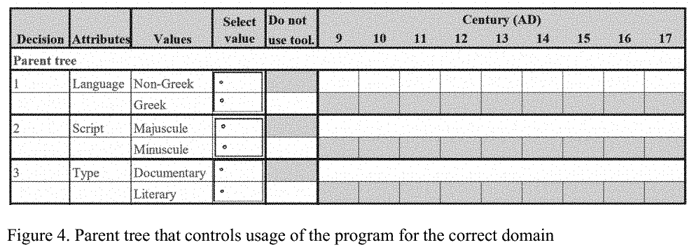

FIG. 4 is a tabular display of the same parent decision tree that displays data graphically and allows user interaction. The minuscule period of Greek literary manuscripts used in the prototype begins in the ninth century AD, so earlier centuries do not need to be displayed. Users will only be allowed to use this model in the program if they select the values for a Greek minuscule literary manuscript.

The computer program will display the remaining attributes and values of the corresponding model so that the user may select values from the model's attributes that match his or her undated test manuscript. With each selection the computer program casts a vote for the date range represented by that selection. When all matching attributes have been selected, the votes are aggregated. For example,

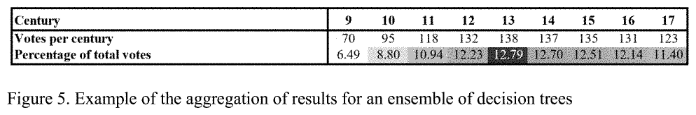

FIG. 5 demonstrates the aggregation for a thirteenth century AD manuscript and the final answer that is returned to the user.

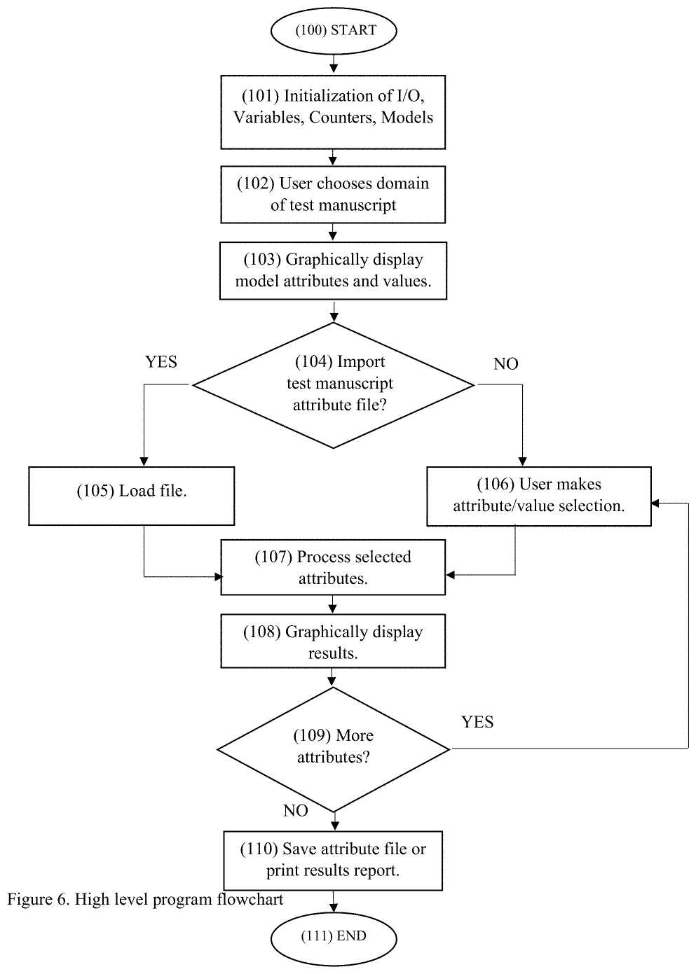

FIG. 6 provides a high-level flow chart of the program. In this section, the numbers in parentheses correspond to the numbers in FIG. 6 regarding how to build the program. The invention may make use of various models of ancient manuscript domains, not only the example shown in the previous figures. A decision tree model of a specific domain of ancient manuscripts as described above provides a database for comparison with an undated manuscript. A single decision tree is represented by one attribute with its corresponding values and the date range for each value in dated manuscripts. For example, the material of a manuscript might be Papyrus, parchment, or paper. The attribute is material, and its values are Papyrus, parchment, and paper. Each of these values may be found during a specific time period. Thus, after the initialization of I/O, variables, and counters, all available manuscript models are loaded (101). Using a parent decision tree that controls the use of the models, the user chooses which model matches his or her test manuscript (102). Thus, the first input to the computer program will be an ensemble of decision trees based on a model or database comprised of many attributes with their corresponding values and dated ranges. This data will be graphically displayed for the user (103).

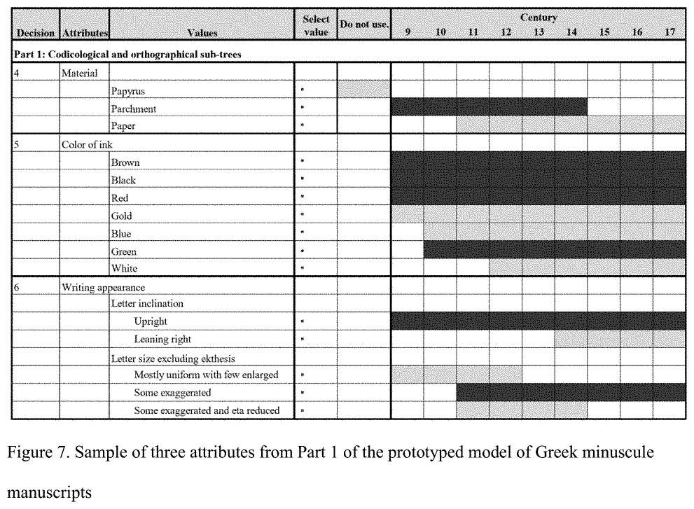

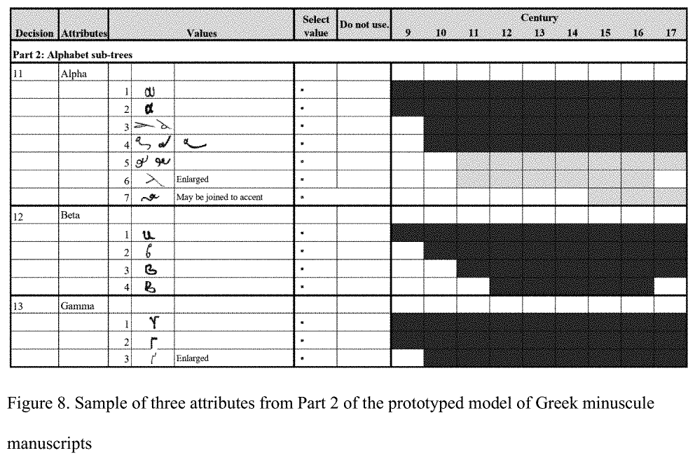

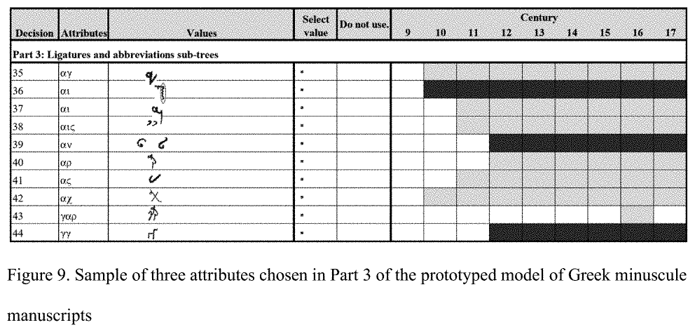

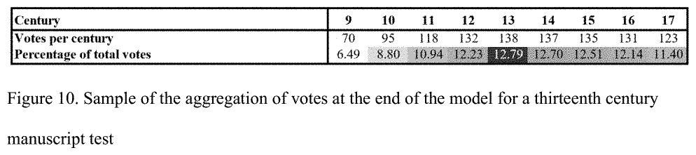

The user of the computer program analyzes an undated test manuscript and selects matching values for each attribute in the model. The user chooses whether this analysis will be input into the program by either a formatted file or an interactive graphical user interface (104). If the user chooses to upload the data in a formatted file, the file is loaded (105). Otherwise, the user selects attributes and values that match the test manuscript using an interactive graphical interface which displays the model (106). When a user selects a value, a vote, which may be weighted, is assigned to the date range represented by the value (107) and is graphically displayed for the user (108). The user analyzes as many of the attributes as possible for the best date range prediction (109). The program computes a secure date for the manuscript based on an aggregation of the votes. The date range receiving the greatest number of votes in the entire ensemble of decision trees becomes the predicted date range, which the user can save or print, along with related statistical charts (110). For example, two if-then-else rules regarding the shapes of letters and ligatures may demonstrate this procedure:
1. For the statement “If phi=‘ [symbol] ,’ then date-range=‘9th-17th centuries,’” a positive vote will be assigned to each of the ninth through seventeenth centuries.
2. Then for the statement “If epsilon-phi ligature=‘ [symbol] ,’ then date-range=‘13th-17th centuries,’” a positive vote will be assigned to each of the thirteenth through seventeenth centuries.
   When the two rules are aggregated, the ninth through twelfth centuries drop in importance for the date-range prediction because these centuries only have one vote compared to two votes for the other centuries. Other attributes will be evaluated similarly to narrow the predicted date range further. An example of attribute selection will be provided in FIGS. 7-10. The date range with the highest number of votes will be the predicted date range.

For the prototype developed for this program, after the parent tree guaranteed the appropriate use of the Greek minuscule literary model for the test manuscript, the remaining decision trees of attributes and related values in the manuscripts were divided into three sections: codicological and orthographical, letters, and ligatures. In total, 134 attributes were identified, which span ten pages in total. Therefore, only the first three attributes of each section will be reproduced in FIGS. 7-10 for the test of a thirteenth century manuscript. The parent tree has been discussed previously and is not pictured again. When the user selects the value of an attribute, the program changes the line in the model from grey to blue as it casts a vote for the corresponding date range. Thus, the user can see graphically the impact of his or her decisions regarding the attributes of an undated test manuscript. The aggregated votes are provided at the end indicating the date range with the highest score. This figure is intended to demonstrate by example one embodiment of the invention and not to limit it to this domain of ancient manuscripts nor to these attributes and formatting of reports.

### B. Detailed Description

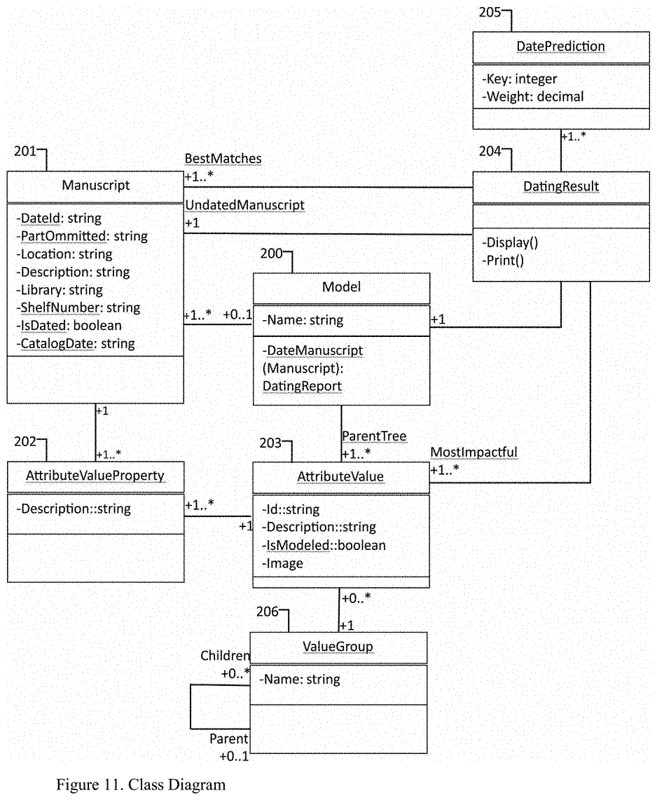

A brief overview and detailed description of the best mode considered by the inventor for implementing the invention will follow. FIG. 11 provides a detailed class diagram in which each class is designated by a letter corresponding to those in the description of classes. However, this description is not intended to limit the application to the described embodiments but to illustrate the spirit of the claims that follow.

The classes include a Model, which contains Manuscripts, and a Manuscript contains AttributeValues. The Manuscript to AttributeValue relationship is defined by the AttributeValueProperty. AttributeValueProperty represents the location by folio number and line number in the manuscript where a value, such as a particular letter shape, is found. DatingResult is the output of comparing an undated manuscript to an omnitextual model and processing the comparison according to decision tree ensemble methodology; DatingResult contains: a date prediction, a manuscript from the model that is the best match to the undated manuscript, the most impactful attribute values that produced the date prediction, and a detail report.

### C. Detailed Description of Classes

Each class in FIG. 11 is described in the outline below, labeled according to the class diagram.

### A. Class: Model (200)

1. Attributes
a. Name is a string that names an omnitextual model, for example, the “Greek minuscule literary model.”

2. Methods
a. The associated method is DateManuscript, which accepts Manuscript as input and produces a DatingReport

3. Relationships
a. A Model contains one or more dated Manuscript.

### B. Class: Manuscript (201)

1. Attributes
a. DateId is a string that identifies each manuscript.
b. PartOmitted is a string that identifies any part of a manuscript that was not modeled. In some cases, manuscripts are a composite of several ancient works which have different dates, and only part of that manuscript is of interest for modeling purposes.
c. Location is a string that identifies the physical location of a manuscript, for example, London.
d. Description is a string that contains a description of the manuscript as reported in its library's catalog.
e. Library is a string that identifies the library where the manuscript resides.
f. ShelfNumber is a string that identifies the library's shelf number for the manuscript.
g. IsDated is a Boolean that indicates whether a manuscript is dated or not. If dated, the manuscript is part of a model. If not, an undated manuscript is not part of a model.
h. CatalogDate is a string that identifies the date of the manuscript as recorded in the library's catalog.

2. Relationships
a. A Manuscript contains one or more AttributeValueProperty.
b. If a Manuscript is in a Model, it will be in only one Model.

### C. Class: AttributeValueProperty (202)

1. Attributes
a. Description is a string of metadata providing the location of an AttributeValue in a Manuscript.

2. Relationships
a. AttributeValueProperty defines the relationship between one Manuscript and one AttributeValue.

### D. Class: AttributeValue (203)

1. Attributes
a. Id is a string that identifies each value of an attribute
b. Description is a string that describes in paleographic terms each value a manuscript attribute may contain. For example, the letter alpha is a manuscript attribute that may be represented by various shapes, and each shape is considered a value of that attribute and is described in paleographic terms.
c. Image is a likeness of the various shapes of letters and ligatures. For example, some of the values for the alpha manuscript attribute are represented with these images: [symbol]
d. Modeled is a Boolean for whether the value is included in the model. For example, sometimes a manuscript has a unique shape for a letter that has not been found in other manuscripts. In that case, the unique shape is noted, but it is considered noise and is not included in the model. If in the future, another manuscript is analyzed and also includes the same shape, then it may be added to the model.

2. Relationships
a. AttributeValue is related to one or more AttributeValueProperty.
b. AttributeValue is in one ValueGroup.

### E. Class: DatingResult (204)

1. Methods
a. Display provides the functionality to display the DatePrediction, BestMatches, MostImpactful, and Detail reports.
b. Print provides functionality to print the DatePrediction, BestMatches, MostImpactful, and Detail reports. 2. Relationships
a. DatingResult is for an UndatedManuscript.
b. DatingResult contains one or more DatePrediction, one or more AttributeValue, and one or more Manuscript.

### F. Class: DatePrediction (205)

1. Attributes
a. Key is an integer representing the date predicted, which may be a century or any other unit of time that is modeled, like half or quarter century.
b. Weight is a decimal that indicates the percentage of votes received for each unit of time in the model.

### G. Class: ValueGroup (206)

1. Attribute
a. Name is used to build a tree structure with multiple levels.

2. Relationships
a. ValueGroup contains zero or more child AttributeValue(s).
b. ValueGroup contains zero or more child ValueGroup(s).
b. ValueGroup may contain one parent.

What is claimed:

1. A method of dating ancient manuscripts, comprising an interactive system:
Receiving as input attribute values of a decision tree based, omnitextual model of dated manuscripts in a manuscript domain (for example, the “Greek minuscule literary” manuscript domain);
Receiving by user input, through either an interface or a file, attribute values of an undated manuscript in the same domain;
Comparing both inputs, attribute values from the omnitextual model and attribute values from the undated manuscript;
Calculating a predicted date range for the undated manuscript using decision tree ensemble processing for quantitative analysis of attribute values found in each time period in the omnitextual model.

2. The method of claim 1, further comprising other supporting details for the predicted date range that may be identified, such as but not limited to:
(a) a manuscript in the omnitextual model that most closely matches the attribute values of the undated manuscript,
(b) attributes that were most impactful in predicting the date range, and
(c) a detail report that graphically displays the undated manuscript's attribute values in relation to those of the omnitextual model for the domain.

3. The method of claim 1, further comprising the ability to use the predicted date range to verify or refute the date of a previously dated manuscript, for example in cases of suspected misdating.

4. The method of claim 1, further comprising, due to the graphical nature of the decision tree-based omnitextual model,
(a) an interactive user experience, by enabling a user (1) to see each attribute value in the omnitextual model, (2) to choose matching attribute values related to the undated manuscript, and (3) to see the impact of their choices on the date prediction produced in claim 1,
(b) an educational user experience, by demonstrating how model-based evidence is used to predict date ranges for ancient manuscripts, which engenders objectivity and confidence in the date prediction made in claim 1.
